(19) United States
(12) Patent Application Publication
(10) Pub. No.: US 2024/0209898 A1
(43) Pub. Date: Jun. 27, 2024

(54) MODULAR SHAFT-HUB CONNECTION CHARACTERISED BY A SHAFT MADE OF REGULAR POLYGONS

(71) Applicant: Neuhaus Maschinenbau GmbH, Schwerte (DE)

(72) Inventor: Dominic Neuhaus, Herdecke (DE)

(73) Assignee: Neuhaus Maschinenbau GmbH, Schwerte (DE)

(21) Appl. No.: 18/569,105

(22) PCT Filed: Jun. 11, 2021
(86) PCT No.: PCT/DE2021/100502

§ 371 Date: Dec. 11, 2023

(51) Int. Cl. F16D 1/08

(52) U.S. Cl. CPC F16D 1/0876; F16D 2300/06

(57) ABSTRACT

The syndisk system is a form of shaft-hub-connection designed to transmit high torques. The effective length of this connection in particular may be increased compared to serrated connections, for example, without significantly increasing the efforts for assembly and, in particular, disassembly. The self-contained sealing and lubrication system also enables high reusability of the shaft, which not only ensures sustainability, but also modularity due to many change and usage possibilities at the hub. In light of the decreased wear and tear and the benefit of not needing any additional connecting elements other than the system, the economic efficiency as a whole along with the usage benefits exceed the increased complexity during production. It does not matter which polygon forms the basis and which point of origin is selected for point E, as the syndisk system is a better system than its base polygon in any case.

At its core, the present invention, hereinafter named “syndisk system”, concerns a special type of connection of a shaft with one or several hubs. It serves as universal carrier or mounting system, characterised by high ease of assembly, modularity of applications as well as a particularly resource-friendly use, made possible by long life of the carrier on the one hand and minimisation of additional mounting components and lubrication devices on the other hand.

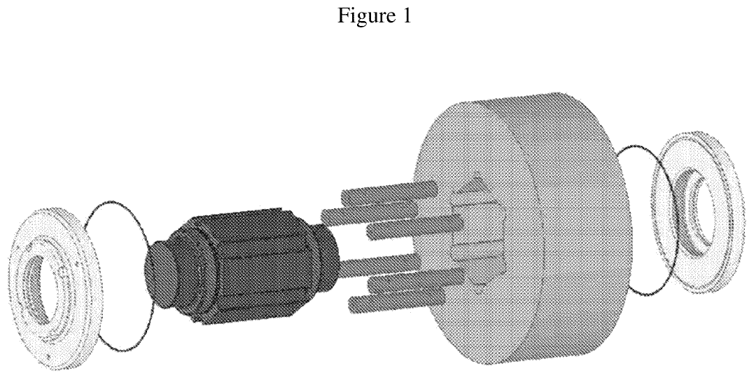

The corresponding geometric design, hereinafter referred to as syndisk geometry, is based on the geometry of any desired regular polygons. However, this new connection between shaft and hub is neither a mere polygonal connection, nor a wedge splice, nor a feather key connection, nor any kind of pinning. Rather, the syndisk system is a unification, i.e. a syncrisis, of connection types, creating a new, holistic system with a new type of shaft-hub-connection with new, additional components. FIG. 1 illustrates the syndisk system primarily composed of a shaft, one or several hubs, multifunctional fitted bolts, and two locks for axial securing and sealing.

FIG. 1 shows components of a complete syndisk system exemplified by a hexagon as base polygon.

In order to transmit torque from a shaft to a hub, many different shaft-hub-connections are known for certain applications and situations. The syndisk system, also serving as a universal carrier system, primarily for the transmission of high torques, additionally provides an exceptionally high ease of assembly, high protection against abrasion, corrosion and adhesion, as well as significant improvement of the surface pressure ratio between shaft and hub. In line with sustainability, the declared primary objectives include maximization of the shaft, establishing modularity and minimising additional single-use components at the same time. At the moment, many mounting techniques are contrasted by many application purposes, leading to inflationary consumption of resources due to wear and tear, deformation of material and practical handling disadvantages. However, in the present case a single new technique stands opposite a multitude of possible applications, resulting in a system of multiplex applications with sustainable character.

In engineering, there are many ways to transmit torque. As already differentiated above, the underlying technique deals with the concrete transmission of torque from a shaft body to a hub or vice versa. In part, these so-called shaft-hub-connections are even standardised and widespread. Depending on the objective, there are connection types better suited to higher or lower torques or having other properties that may be more advantageous depending on the application. Therefore, the most well-known connections with the widest distribution and, hence, standardisation include the following types of shaft-hub-connections: for example, feather key connection, splined shaft, polygon and serrated shaft connections, as well as connections with clamping elements. The following matrix gives an overview of the properties of the respective connection type in relation to various parameters.

TABLE 1
Properties of connection types

| Connection type | Feather | Splined | | | Clamping |
|---|---|---|---|---|---|
| Property | key | shafts | Polygon | Serration | element |
| Notch effect | − | − | + | − | + |
| − high/+ low | | | | | |
| Torque | − | + | + | + | + |
| − low/+ high | | | | | |
| Surface pressure | − | + | + | + | + |
| − high/+ low | | | | | |
| Ease of assembly | + | − | + | + | − |
| − low/+ low | | | | | |
| Degree of self- centring | + | + | + | + | − |
| − low/+ high | | | | | |
| Manufacturing complexity | + | − | − | − | + |
| − high/+ low | | | | | |
| Flexibility | + | − | + | − | − |
| − low/+ high | | | | | |
| Modularity | − | − | + | + | − |
| − low/+ high | | | | | |
| Wear and tear | − | + | − | − | − |
| − high/+ low | | | | | |
| Degree of sustainability | − | − | − | − | − |
| − low/+ high | | | | | |

The matrix compares five of the most well-known shaft-hub-connections based on ten criteria. Green fields are marked “+” and describe generally positive properties in relation to the criterion (without quantifying them). In light of the focus on the optimisation of transmission of torque, an advantageous surface pressure ratio between shaft and hub, and high ease of assembly while simultaneously taking into account use of resources and modularity, the conventional connection types feather key, spline shaft and clamping elements are eliminated upon further consideration, as their properties do not meet at least one of the five target criteria.

And while serration is extremely well-suited to the transmission of high torque and is probably the connection with the highest degree of standardisation, its sustainability and modularity are severely limited. The length of the serration is extremely limited, therefore leading to a limited range of application, i.e. restricted modularity. The susceptibility of the flanks of toothing increases with form closure, i.e. the larger the surface area and form closure are, the finer and more numerous the cogs are. This in turn is bad for high repeat usage, as the potential for damages increases with each cog.

Out of the available shaft-hub-connections, the conditions of the polygon are therefore suited best to meet the target criteria simultaneously, but still only partially.

Based on the types of connections compared above, the following objective may be formulated:

How can a technical basis be derived from the advantages of the existing shaft-hub-connections for a systematic expansion and/or combination of connection types, strictly pursuing the five target criteria?

The comparison of existing shaft-hub-connections has shown that polygon connections have a particularly large potential to meet the target criteria, as they are better suited for greater lengths in contrast to serration connections and as the application of multiple hubs is easier with them. As high form closure and large surface areas result in significant frictional resistance during assembly work for both serration and polygon connections, reducing them is a primary objective for the technical solution of the problem. However, this leads to ambivalence, as the premise of improvement or at least safeguarding of the positive properties has to be adhered to.

Hence, the objective shall be specified in such a way that a new form of a shaft-hub-connection:

1. Describes the ability to reduce the surface area and thus the frictional resistance for assembly purposes, i.e. for moving one or several hubs on the shaft and for wear protection, but to increase it in the form closure or to be at least equal to the initial state.

2. Furthermore, a solution has to be found that allows for even lubrication of all surface areas between shaft and hub, regardless of the length of the shaft or number of hubs, so as to maximise ease of assembly and sustainable reusability. Herein, the degree of complexity of the shaft and hub may not be increased by complex lubrication channels from the outside to the shaft-hub-connection; rather, lubrication should ideally be possible from the inside.

### DESCRIPTION

The syndisk system is a new form of connecting a shaft with one or several hubs, based on regular polygons, with the objective of unifying high ease of assembly, resource-friendly production and a high degree of resistance to wear and tear. At the same time, positive properties of polygon connections, for example extremely high torque transmission, low notch effect and surface pressure ratio may not be undercut, but should at least remain the same or even be improved.

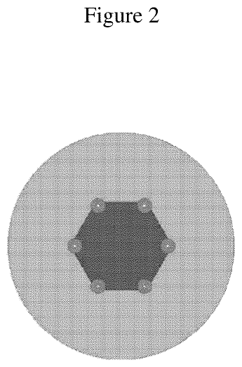

FIG. 2 shows a cross-section of a syndisk system using the example of a hexagon.

The initial geometry of the shaft always is an arbitrary regular polygon, preferably a pentagon, hexagon or heptagon. This geometry is expanded along the respective intersection lines of the areas with a longitudinal slot, i.e. in axial direction. The groove geometry is characterised in being round and its dimensional design being in a fixed relation to the circle centre of the intersections, the number of corners and the side distance by a formula applicable to all polygons. See also the technical-mathematical background below.

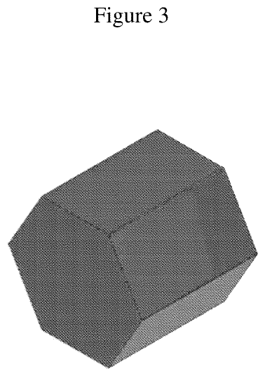

FIG. 3 shows a cross-section of a syndisk system using the example of a hexagon.

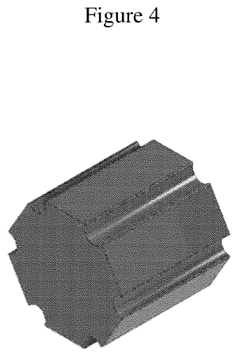

FIG. 4 shows an applied formula for the formation of (positive) syndisk geometry.

The hub is the counterpart to the shaft and is therefore described with negative geometry in addition to the geometry of the shaft with mutually identical parameters. This results in a first positive and frictional lock between shaft and hub, but with less surface area than a pure polygon in this state, namely less by exactly the cross-sectional area of the grooves that the initial polygon has at the intersection lines. When comparing the area of a conventional polygonal shaft-hub-connection with that of a syndisk geometry without bolts, the area of the syndisk geometry is significantly smaller.

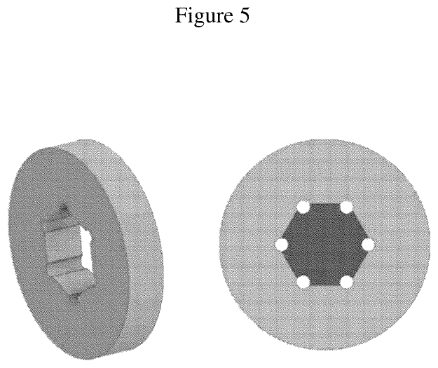

FIG. 5 shows a hub with negative syndisk geometry (left) and shaft and hub with syndisk geometry in the system (right)

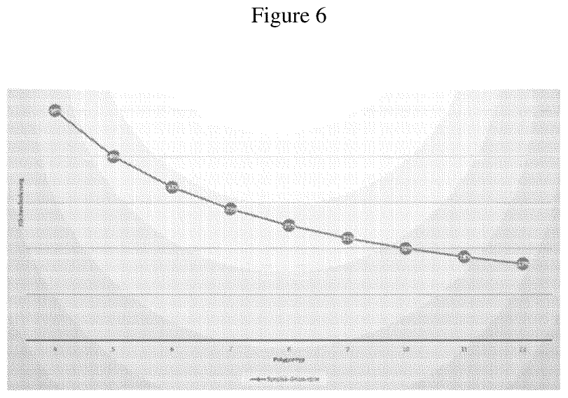

FIG. 6 gives an illustrative example for a change in area without bolts for many types of polygons. For a square, the surface area without bolts is minimised by half and for a hexagon still by one third. As a consequence, this significantly smaller area means an enormous loss of frictional resistance for assembly work, i.e. significantly less force and expense is required to mount the hub on the shaft or remove it from the shaft, which can be achieved by simply pushing it on or off.

FIG. 6 shows changes of the polygon surface through syndisk geometry.

Once shaft and hub are connected as illustrated in FIG. 5, the third component of the system, a multifunctional fitted bolt, is also inserted into any resulting through hole in the form closure of the round grooves. Here, it is important to understand that this is by no means and arbitrary pinning. The bolt is specified with a fixed formula and always exactly as long as the syndisk geometry in axial direction on the shaft. Furthermore, the number of bolts is also firmly defined by the number of corners of the base polygon. The bolt has the following functions:
The footing of the hub on the shaft is improved by the form closure (fitted bolt).
Lubrication channels in axial and radial direction across the entire length do not only ensure easy disassembly and assembly of the bolts, but the location on the intersection lines of two contact surfaces also enables simultaneous lubrication of two surface areas between shaft and hub. This results in double-sided lubrication of a single area. In this way, the “adhesion” typical to other shaft-hub-connections is avoided or minimised by corrosive processes and friction through force application between shaft and hub and kept intact for disassembly. Hence, neither the shaft nor the hub need to be equipped with a complex lubrication system. The bolt can be easily pulled through threads on the face side or handled with locksmith tools during disassembly and assembly, and lubrication connections can simply be screwed on at the face side.
By using the bolts, the area between shaft and hub is changed.
   Without bolts, it is easier to mount or remove one or several hubs on or from the shaft, as the frictional resistance is significantly reduced by the syndisk geometry.
   On the other hand, bolts cause the opposite to happen, i.e. a disproportionate increase in surface area of the shaft and hub. Depending on the polygonal basis, this increase may be significantly larger than the original polygon shape and allows for a higher torque transmission or a change in the surface pressure ratio of the components.

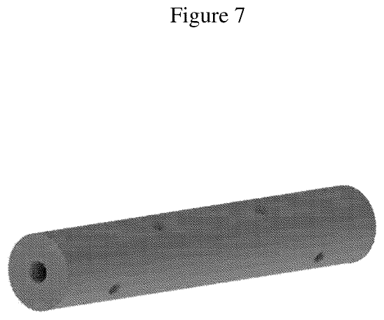

FIG. 7 shows an example of a multifunctional fitted bolt of the syndisk system.

The example of a hexagon shows how the entire contact surface of shaft and hub is lubricated from 12 directions across the entire length of the geometry, as demonstrated in the illustration below.

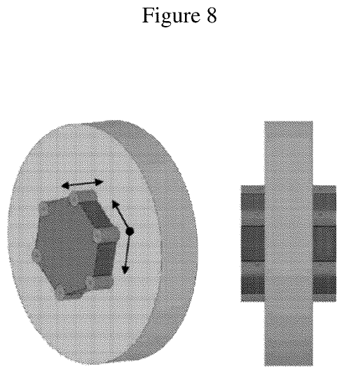

FIG. 8 shows an excerpt of the syndisk system focusing on the surface lubrication through the multifunctional fitted bolts.

Depending on the intended purpose, one or several hubs may be pushed onto the shaft, which are locked in radial direction by the form closure and absorb the forces from the shaft through the geometry. The hubs and bolts are held together, secured and most importantly sealed in axial direction by a lock. In radial direction, the hubs have to be fitted with a simple sealing on the flat surface (O-ring, etc.), in order to avoid leakage of lubrication due to rotational forces and the ingress of dirt and water.

The lock of the syndisk system is composed of two equal multifunctional sealing lids, having the following purposes:
The appropriate axial force is generated through a thread, so as to push the hubs onto each other and ensure radial sealing. Depending on the target application, the form and type of the thread needs to be adapted to the required axial force.
A shaft seal prevents the lubrication of the closed system from leaking through the shaft in axial direction at both ends.
With appropriate shapes at the outer circumference (e.g. for a hook wrench) of the sealing lid, it may be simply handled like a shaft nut with conventional assembly tools.

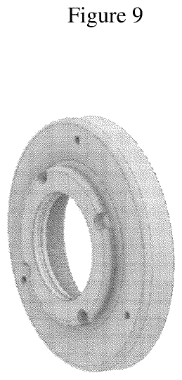

FIG. 9 shows an embodiment of a possible syndisk sealing lid with notches for a hook wrench.

The syndisk system is complete once the following four components:
shaft with positive syndisk geometry
hub with negative syndisk geometry
multifunctional fitted bolt
locking system (lid with sealing and tightening function) are fully mounted.

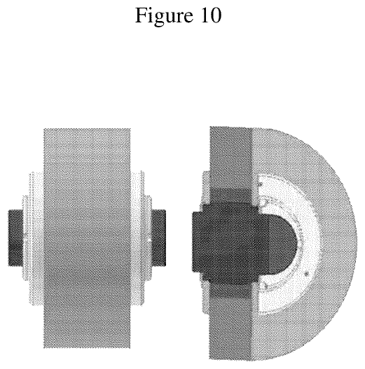

FIG. 10 shows the composition of a complete syndisk system.

The special feature is that, starting from the hexagon as base profile, all properties of the respective polygonal shaft-hub-connection are exceeded for both the shaft and the hub. Furthermore, a new self-contained system is created that does not require any mandatory repeat lubrication or additional fastening elements such as expensive clamping sets. Furthermore, conservation of the shaft provides high reusability in addition to particular ease of assembly due to advantageous changes in surface pressure ratio as well as avoiding or decreasing corrosion, abrasion and adhesion. Using the example of greatly reduced surface pressure due to the syndisk geometry at the hub, a resource-saving or alternative material may be used in contrast to conventional connection types, which may be particularly advantageous for sustainability-oriented applications. In potential applications with modular shaft-hub-systems, one shaft may even be used multiple times for different types of hubs.

### Technical-Mathematical Explanations

A positive-fitting and friction-locked shaft-hub-connection with a regular polygon as output profile forms the basis of the system. Herein, the polygon is determined by the angle alpha being
45° less or equal α less 90°
   or
π/4 less or equal α less π/2
   meaning that all regular polygons from and including the square may be used. For the shaft, the initial profile is changed into a new profile geometry P(Syn) across the total length L (poly) at all corners, where n represents the number of corners, with a groove of length L (poly) and a round base, the centre of which is the respective corner point E with the radius according to the formula

$$r = α / n$$

with a as the edge length of the equilateral triangle of the total of n equal triangles forming the polygon. For the hub, the identical profile geometry is shown as negative P(syn) to the power of −1, so that when these two planes are superimposed, n circles with the size 2*r are produced or, in the specific case of shaft and hub, n cylindrical free spaces with the length L(syn). The resulting cylinders are sealed by means of positive-locking bolts with clearance fit over the length L(syn). The points created by the intersection of the transition from the base side of the polygon triangle to the respective radius are rounded off so that the new profile geometry does not have sharp edges but 2*n chambers across the length L(syn). As a result, this minimises any notch effects and leads to an important function for the practical application. Furthermore, the original surface area F(poly) of the conventional polygon is increased from

$$F ( poly ) = α * n$$

to
ΔF=2α*(α−1), with α in radian, through connection with the bolt.

Hence, the following applies to the surface area of the new connection at the hub:

$$F ( syn ) = α * n + [ 2 α * ( α - 1 ) ]$$

The new connection of shaft and hub is neither a pure polygon connection, nor a pure wedge splice, nor a pure feather key connection, nor a pin connection, but rather a unification, i.e. a syncrisis of connection types, creating a new system or special variant.

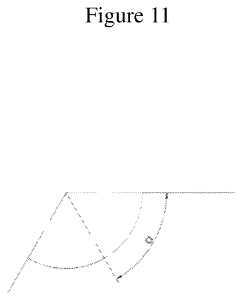

FIG. 11 shows an angle alpha.

The Figure below illustrates the relative change in surface area of the syndisk geometry compared to the geometry of pure regular polygons on the one hand and the relation between the relative change in surface area of the shaft and the hub on the other hand. Furthermore, the additional consideration of the degree of complexity postulates the economic profitability of the model on the basis of a linearly increasing determinant, as it is assumed that the production of a geometry based on an octagon is twice as labour-intensive as that on the basis of a square.

Hence, the degree of complexity of the underlying model may be described with the linear functional equation

$$f ( x ) = 1 / 4 * ( x - 4 ) ,$$

$$with$$

$$0 ( 4 \vert 0 )$$

as model determinant.

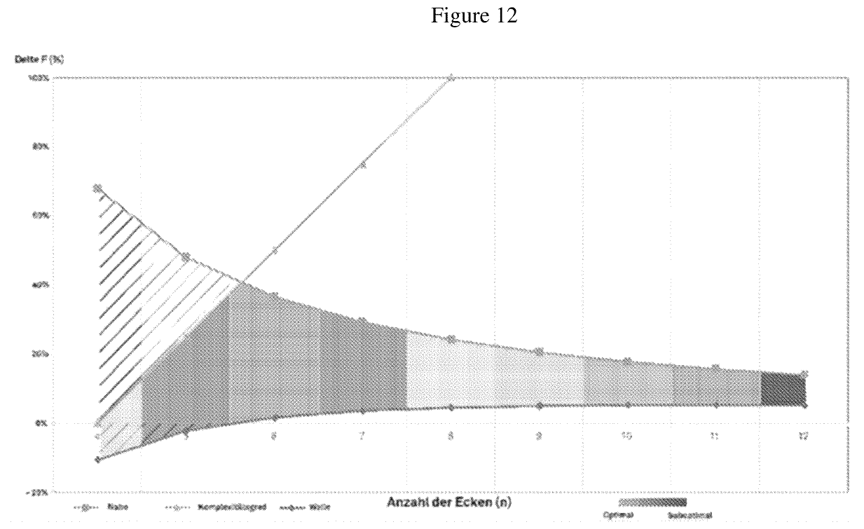

FIG. 12 shows the relative surface variation at the components.

The abscissa describes the number of corners of a pure polygon contour, with the ordinate describing the changes in relation to it, i.e. an increase or decrease in surface area. The origin of the graph is at the square, as the loss of area of the shaft of approx. 20% compared to the increase in area of the hub of approx. 67% is still acceptable and can therefore be practicable with regard to a potential application with a focus on the hub.

When looking only at the shaft, it becomes apparent that the curve rises noticeably up to the octagon after intersecting with the abscissa at the hexagon and then becomes steadily flatter. Hence, there is a significant increase in area for hexagons, heptagons and octagons. Therefore, the relation between an increasing number of corners and the increase in area is progressive.

On the other hand, the curve progression of the hub depicts a degressive course, i.e. the increase of the surface area slows significantly with an increasing number of corners. When additionally taking into account the degree of complexity, i.e. the technical effort to create the geometries, the field of potential usability is further limited.

The relationship between ΔF(shaft) and ΔF(hub) becomes very clear as the number of corners increases, which is ultimately due to the fact that an infinite number of corners results in a round shaft and the system theoretically no longer having any function. At the beginning, both curves diverge widely, which in turn is caused by the size of the internal angles of the triangles, as the hub forms larger circumferences in the internal contour at a few corner points, while the shaft becomes negative due to the positively correlated ratio of alpha to n in relation to delta F.

Thus, an optimum may be defined with the following properties, which need to be fulfilled at the same time:
Economic profitability exists if the range is below the intersection of the degree of complexity with the hub.
The optimal range has to be located between the two curves of shaft and hub in order to ensure mutual advantageous benefits.
A pareto-efficient state is reached at the exact moment in which it is no longer possible to improve a property without having to impair another one.
No negative range may be added between the graphic funnel of shaft and hub. Thus, only the area above the 0% line may be taken into account.

With this combination of determinants, the hexagon (light green area) has the largest area and therefore the largest added value in the illustration. With respect to the larger surface area, the shaft has an increase of almost 5% and the hub of more than one third in comparison to the geometry of a pure regular polygon. The degree of complexity is still within the economically attractive range, meaning that the cost of producing the syndisk geometry is lower than the resulting benefit. Furthermore, a significantly lower surface pressure at the hub contributes to both technical and economic effects being achieved in potential applications, as the material is put under less stress. Hence, the syndisk geometry on basis of a hexagon is optimal or pareto-optimal and has the highest economic cost-benefit relation depending on the intended use, provided that there is equal weighting of benefits for shaft and hub.

The dark green areas show variants, which under different premises such as
disregard or amendment of the degree of complexity through better production possibilities or changes in production factors,
focus on keeping the surface pressure at the hub as low as possible, and
different weighting of potential operational purposes and target use may also be optimal variants for users. For example, it can be argued for the pentagon that more advantageous production factors and lower weighting of delta-F shaft may constitute a hypothetical optimum for the user.

What is claimed is:

1. A modularly constructed shaft-hub-connection, comprising a shaft characterised in being based on equilateral and equiangular polygons, whose respective corner points are expanded by multifunctional fitted bolts along the rotational axis of the shaft, and consisting of one or several hubs with the reverse geometry of the shaft, as well as dual-sided axial locks.

2. The modularly constructed shaft-hub-connection according to claim 1, with exactly the same number of multifunctional fitted bolts as the number of corners by which the underlying polygon is characterised.

3. The modularly constructed shaft-hub-connection according to claim 2, with the multifunctional fitted bolts being characterised in their radius being the quotient mathematically resulting from dividing the circumcircle diameter of the shaft's polygon by the number of its corners and its length always being equal to the connection of the shaft and one or several hubs.

4. The modularly constructed shaft-hub-connection characterised according to claim 3, whose multifunctional fitted bolts are variably positioned from the corner point with regard to the application-specific surface pressure, namely exclusively along the connecting line between the shaft's centre point and the respective corner point of the polygon, within the value range of the difference of corner point and bolt radius in relation to the sine of the internal angle of the polygon in minimum as well as the sum of corner point and bolt radius in maximum.

5. The modularly constructed shaft-hub-connection according to claim 4, with the length of the grooves in the shaft and hub corresponding exactly to the length of the multifunctional fitted bolts, and shaft and hub together having exactly as many hollow cylinders as defined by the number and dimensions of the bolts.

6. The modularly constructed shaft-hub-connection according to claim 5, with the position of the hollow cylinder being variable within the value range on the connecting line between the centre of the shaft and the corner point.

7. The modularly constructed shaft-hub-connection according to claim 6, and which, in combination of all components, is required to reduce the surface pressure by the increase in the polygonal surface area compared to a pure polygonal connection with identical dimensions.

8. The modularly constructed shaft-hub connection according to claim 7, configured for reducing the frictional resistance of the original pure polygonal shell surface exactly by that of the contact surface with the bolts without multifunctional fitted bolts.

9. The modularly constructed shaft-hub-connection according to claim 8, configured to provide the multifunctional fitted bolts with a continuous longitudinal bore and an indefinite number of connecting bores on the circumference, the outlet opening of which is located exactly on the contact surface of shaft and hub, in order to achieve full-surface lubrication of the contact surfaces in the compound by means of a lubricant.
